(19) United States
(12) Patent Application Publication
(10) Pub. No.: US 2002/0140388 A1
(43) Pub. Date: Oct. 3, 2002

(54) Apparatus for controlling rearview mirror angle for use in a vehicle

(76) Inventor: Dae Gi Lee, Inchon-shi (KR)

Correspondence Address: Eric Bleich, Trademark and Patent, Counselors of America, P.C., 915 Broadway - 19th Floor, New York, NY, 10010, US

(21) Appl. No.: 09/893,863

(22) Filed: Jun. 28, 2001

(30) Foreign Application Priority Data
Apr. 3, 2001 (KR) 2001-17605

(51) Int. Cl. H02P 1/00; H02P 3/00; G05B 5/00; H02P 7/00; H02H 7/08

(52) U.S. Cl. 318/445

(57) ABSTRACT

An apparatus for controlling a rearview mirror angle of vehicles, includes an overcurrent sensing unit for generating a trip signal for driving a photo coupler when overcurrent is applied to a driving motor, a poly-switch being connected to one input terminal of the driving motor, and connected in parallel to a resistor; an initial driving and off maintaining unit for driving the driving motor when power is inputted to input terminals, and maintaining an off status of the driving motor when the trip signal is inputted from the overcurrent sensing unit; and a relay turned on/off according to driving of the initial driving and off maintaining unit, for interrupting forward/backward power supplied to the driving motor. In accordance with the present invention, the apparatus for controlling the rearview mirror angle of vehicles can reduce a volume by miniaturizing components of the circuit unit for controlling the rearview mirror angle, simplify the whole assembly process, cut down a production cost, and use components performing repeated operations without a mis-operation.

### BACKGROUND OF THE INVENTION

1. Field of the Invention

The present invention relates to an apparatus for controlling a rearview mirror angle of vehicles, and more particularly to an improved apparatus for controlling a rearview mirror angle of vehicles which can control the rearview mirror angle by driving a driving motor at an initial stage of operation, and which can maintain a current status after a predetermined time.

2. Description of the Prior Art

A rearview mirror is very useful to observe a rear peripheral environment of a vehicle. A driver should frequently control driving through the rearview mirror. In addition, the rearview mirror is optically installed in a visual field of the driver, so that the driver can easily observe the rear state of the vehicle.

However, in the case of public vehicles operated by various drivers, the rearview mirror does not correspond to the optical system of the driver. Thus, every driver should control an angle of the rearview mirror.

At this time, an angle control time is increased, and the rearview mirror angle cannot be precisely controlled. Accordingly, the driver may unstably drive the vehicle, and cause a serious traffic accident due to a rear blind area.

In order to solve the foregoing problem, a driving motor is connected to a rearview mirror, and a rearview mirror angle is controlled by switch operation. However, a circuit for driving the driving motor is complicated, an assembly process time is increased due to manual operation, and a production cost is increased. In general, current supplied to the driving motor is controlled by using a Triac. In an initial control operation, mis-operations may be generated due to repeated operations by an inversion plug socket.

### SUMMARY OF THE INVENTION

Accordingly, a primary object of the present invention is to provide an apparatus for controlling a rearview mirror angle of vehicles which can control the rearview mirror angle by driving a driving motor at an initial stage of operation, and which can maintain a current status after a predetermined time.

Another object of the present invention is to provide an apparatus for controlling a rearview mirror angle of vehicles which can reduce a volume by miniaturizing components of a circuit unit for controlling the rearview mirror angle, simplify the whole assembly process, cut down a production cost, and use components performing repeated operations without a mis-operation.

In order to achieve the above-described objects of the present invention, there is provided an apparatus for controlling a rearview mirror angle of vehicles, including: an overcurrent sensing unit for generating a trip signal for driving a photo coupler when overcurrent is applied to a driving motor, a poly-switch being connected to one input terminal of the driving motor, and connected in parallel to a resistor; an initial driving and off maintaining unit for driving the driving motor when power is inputted to input terminals, and maintaining an off status of the driving motor when the trip signal is inputted from the overcurrent sensing unit; and a relay turned on/off according to driving of the initial driving and off maintaining unit, for interrupting forward/backward power supplied to the driving motor.

The initial driving and off maintaining unit includes: a resistor and a capacitor for applying the input power from an initial driving resistor or the trip signal from the photo coupler to a base of a first transistor in the form of a high or low voltage according to a charging/discharging operation; the first transistor turned on/off according to the high or low voltage from the resistor and the capacitor; a second transistor inversely driven from the first transistor, for interrupting a current flowing through the relay; a resistor connected to the capacitor and a collector of the second transistor, for feeding back a discharging voltage of the capacitor; and a bridge circuit having two diodes for supplying power through a motor terminal in a constant direction.

### BRIEF DESCRIPTION OF DRAWINGS

The present invention will become better understood with reference to the accompanying drawing, which is given only by way of illustration and thus is not limitative of the present invention, wherein:

FIG. 1 is a schematic diagram illustrating an apparatus for controlling a rearview mirror angle of vehicles in accordance with the present invention.

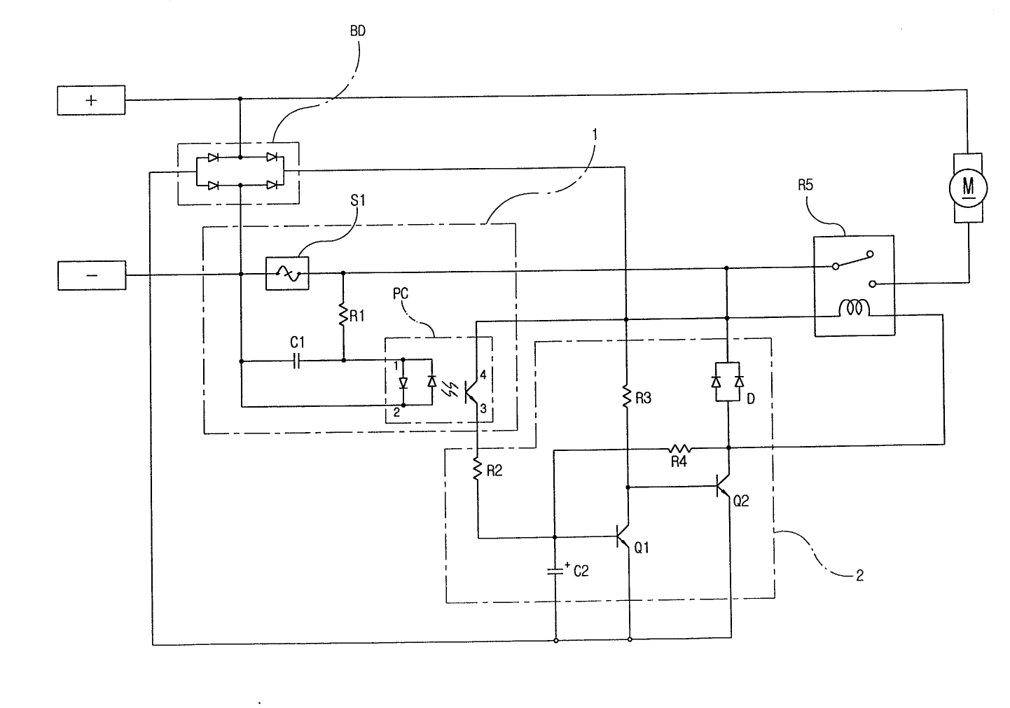

### DETAILED DESCRIPTION OF THE PREFERRED EMBODIMENTS

An apparatus for controlling a rearview mirror angle of vehicles in accordance with the present invention will now be described with reference to the accompanying drawing.

When a discharging voltage of a capacitor C2 is applied to a base of a transistor Q1 in the form of a low voltage, if power is inputted through input terminals (+,−), power is rectified by a bridge diode BD and passed through a relay RY and a transistor Q2 to maintain an on status of the relay RY, and thus a driving motor M starts to be driven. Here, the discharging voltage of the capacitor C2 is fed back through a resistor R4 and passed through the transistor Q2, thus maintaining a current status.

When the driving motor M is being driven, if overcurrent is applied to a poly-switch S1 through the driving motor M, the current applied to the polyswitch S1 (current sensor shorted over a predetermined current) is applied to a photo coupler PC through a resistor R1 and a capacitor C1, to generate a trip signal. At this time, decided is a delay time of stopping the driving motor M after sensing the overcurrent according to a charging/discharging timing of the resistor R1 and the capacitor C1. Here, the voltage supplied to the driving motor M, a trip and a trip point can be changed due to variations of a resistance value of the resistor R1, and a trip time can be adjusted by varying a time constant of the resistors R1, R2 and the capacitor C2.

When the photo coupler PC is driven according to the trip signal generated due to the overcurrent sensing of the driving motor M, the capacitor C2 is completely charged with the input power from the photo coupler PC, and the base of the transistor Q1 is at a high voltage. Therefore, the transistor Q2 is turned off, and the current flowing through the relay RY is interrupted to stop the driving motor M. This state is maintained until power is re-supplied through the resistor R4 or power is supplied in a backward direction.

That is, when the input power is supplied through the input terminals (+, −), the input power is rectified through the bridge diode BD and applied to the base of the transistor Q1 through the relay RY and the resistor R4. However, the applied power is charged in the capacitor C2, and the base of the transistor Q1 maintains a low voltage status. Accordingly, the transistor Q1 is turned off and the transistor Q2 is turned on, to drive the driving motor M.

Especially, when the transistor Q2 is turned on, power is applied to the base of the transistor Q1 through the resistor R4 in the form of a low voltage, and thus the current status is continuously maintained.

Here, when consumption current of the driving motor M is sensed by the poly-switch S1, if the overcurrent is sensed, the trip signal delayed for a predetermined time by the resistor R1 and the capacitor C1 is generated to drive the photo coupler PC. Thus, the transistor Q1 is turned on, the transistor Q2 is turned off, and the relay RY is turned off, thereby stopping the driving motor M. The transistors Q1, Q2 maintain the current status until the power is re-supplied.

The diodes D serve to prevent the transistor Q2 from being damaged due to a backward voltage generated in the operation of the relay RY.

As discussed earlier, in accordance with the present invention, the apparatus for controlling the rearview mirror angle of vehicles can reduce a volume by miniaturizing components of the circuit unit for controlling the rearview mirror angle, simplify the whole assembly process, cut down a production cost, and use components performing repeated operations without a mis-operation.

As the present invention may be embodied in several forms without departing from the spirit or essential characteristics thereof, it should also be understood that the above-described embodiment is not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

What is claimed is:

1. An apparatus for controlling a rearview mirror angle of vehicles, comprising:
an overcurrent sensing unit for generating a trip signal for driving a photo coupler when overcurrent is applied to a driving motor, a poly-switch being connected to one input terminal of the driving motor, and connected in parallel to a resistor;
an initial driving and off maintaining unit for driving the driving motor when power is inputted to input terminals, and maintaining an off status of the driving motor when the trip signal is inputted from the overcurrent sensing unit; and
a relay turned on/off according to driving of the initial driving and off maintaining unit, for interrupting forward/backward power supplied to the driving motor.

2. The apparatus according to claim 1, wherein the initial driving and off maintaining unit comprises:
a resistor and a capacitor for applying the input power from an initial driving resistor or the trip signal from the photo coupler to a base of a first transistor in the form of a high or low voltage according to a charging/discharging operation;
a first transistor turned on/off according to the high or low voltage from the resistor and the capacitor;
a second transistor inversely driven from the first transistor, for interrupting a current flowing through the relay;
a resistor connected to the capacitor and a collector of the second transistor, for feeding back a discharging voltage of the capacitor; and
a bridge circuit having two diodes for supplying power through a motor terminal in a constant direction.
